(19) United States
(12) Patent Application Publication
(10) Pub. No.: US 2022/0373650 A1
(43) Pub. Date: Nov. 24, 2022

(54) RANGING DEVICE

(71) Applicant: KOITO MANUFACTURING CO., LTD., Minato-ku, Tokyo (JP)

(72) Inventor: Hiroshi INOUE, Shizuoka-shi, Shizuoka (JP)

(73) Assignee: KOITO MANUFACTURING CO., LTD., Minato-ku, Tokyo (JP)

(21) Appl. No.: 17/765,901

(22) PCT Filed: Sep. 14, 2020
(86) PCT No.: PCT/JP2020/034663

§ 371 Date: Apr. 1, 2022

(30) Foreign Application Priority Data
Oct. 2, 2019 (JP) 2019-182171

(51) Int. Cl. G01S 7/481; G01S 17/931

(52) U.S. Cl. CPC G01S 7/4811; G01S 17/931

(57) ABSTRACT

A light emitting element (151) is configured to emit detecting light (L1). A first lens (152) is configured to allow passage of the detecting light (L1). A first optical fiber (153) is configured to guide the detecting light (L1) to the first lens (152). A second lens (154) is configured to allow passage of reflected light (L2) that is the detecting light (L1) reflected by an object (200). A second optical fiber (155) is configured to guide the reflected light (L2) having passed the second lens (154) to a light receiving element (156). A processor (157) is configured to calculate a distance to the object (200) based on a time length from time when the detecting light (L1) is emitted from the light emitting element (151) to time when the reflected light (L2) is incident on the light receiving element (156).

The presently disclosed subject matter relates to a ranging device adapted to be equipped in a mobile entity.

### BACKGROUND

Patent Document 1 discloses a LiDAR (Light Detecting and Ranging) sensor adapted to be equipped in a vehicle as an example of a ranging device adapted to be equipped in a mobile entity. The LiDAR sensor detects a distance to an object that generated reflected light based on a time length from the time when detecting light is emitted to the time when the reflected light is received.

### CITATION LIST

### Patent Document

Patent Document 1: Japanese Patent Publication No. 2018-049014 A

### SUMMARY

### Technical Problem

It is demanded to improve the flexibility as to the layout of the ranging device in a mobile entity.

### Solution to Problem

In order to meet the demand described above, an illustrative aspect of the presently disclosed subject matter provides a ranging device adapted to be equipped in a mobile entity, comprising:

a light emitting element configured to emit detecting light:

a first lens configured to allow passage of the detecting light:

a first optical fiber configured to guide the detecting light to the first lens;

a second lens configured to allow passage of reflected light that is the detecting light reflected by an object;

a light receiving element;

a second optical fiber configured to guide the reflected light having passed the second lens to the light receiving element; and

a processor configured to calculate a distance to the object based on a time length from time when the detecting light is emitted from the light emitting element to time when the reflected light is incident on the light receiving element.

According to such a configuration, it is possible to alleviate the constraint on the positional relationship between the light emitting element and the first lens. As long as the first lens is disposed at a position allowing the passage of the detecting light for detecting the distance to the object located in a prescribed area outside the mobile entity, the position of the light emitting element can be determined with high flexibility in accordance with the circumstances of the first lens. This is because the detecting light emitted from the light emitting element so disposed can be guided to the first lens by the first optical fiber having flexibility and a length that can be freely determined.

Similarly, it is possible to alleviate the constraint on the positional relationship between the light receiving element and the second lens. As long as the second lens is disposed at a position allowing the passage of the reflected light from the object located in a prescribed area outside the mobile entity, the position of the light receiving element can be determined with high flexibility in accordance with the circumstances of the second lens. This is because the reflected light that has passed through the second lens can be guided to the light receiving element so disposed by the second optical fiber having flexibility and a length that can be freely determined.

Therefore, the flexibility as to the layout of the ranging device in the mobile entity can be enhanced.

In order to meet the demand described above, an illustrative aspect of the presently disclosed subject matter provides a sensor module adapted to be equipped in a mobile entity, comprising:

a housing defining an accommodation space;

a sensor disposed in the accommodation space and configured to detect information of a first area where is outside of the mobile entity;

a ranging device disposed in the accommodation space and configured to detect a distance to an object located in a second area where is outside of the mobile entity and different from the first area; and

a processor,

wherein the ranging device comprises:
a light emitting element configured to emit detecting light;
a first lens configured to allow passage of the detecting light;
a first optical fiber configured to guide the detecting light to the first lens;
a second lens configured to allow passage of reflected light that is the detecting light reflected by an object;
a light receiving element; and
a second optical fiber configured to guide the reflected light having passed the second lens to the light receiving element; and

wherein the processor is configured to calculate a distance to the object based on a time length from time when the detecting light is emitted from the light emitting element to time when the reflected light is incident on the light receiving element.

According to such a configuration, in addition to the above advantages, the detecting range of the ranging device can be set so as to compensate for the blind spot of the detecting range of the sensor. Even if the first lens and the second lens are arranged so as to realize such a detecting range, the layouts of the light emitting element and the light receiving element can be determined with high flexibility in accordance with the arrangement of the sensor in the accommodation space by using the first optical fiber and the second optical fiber having flexibility and lengths that can be freely determined.

As used herein, the term “light” means an electromagnetic wave having an arbitrary wavelength capable of detecting desired information. For example, “light” is a concept including not only visible light but also ultraviolet light, infrared light, millimeter waves and microwaves.

### BRIEF DESCRIPTION OF DRAWINGS

FIG. 1 illustrates a configuration of a sensor module according to an embodiment.

FIG. 2 illustrates a vehicle in which the sensor module of FIG. 1 is to be equipped.

FIG. 3 illustrates a configuration of a sensor module according to another embodiment.

### DESCRIPTION OF EMBODIMENTS

Examples of embodiments will be described below in detail with reference to the accompanying drawings. In each of the drawings used in the following descriptions, the scale is appropriately changed in order to make each member have a recognizable size.

In the accompanying drawings, an arrow F represents a forward direction of the illustrated structure. An arrow B represents a rearward direction of the illustrated structure. An arrow U represents an upward direction of the illustrated structure. An arrow D represents a downward direction of the illustrated structure. An arrow L represents a leftward direction of the illustrated structure. An arrow R represents a rightward direction of the illustrated structure. The terms “left” and “right” used in the following descriptions represent the leftward direction and the rightward direction as viewed from a drivers seat.

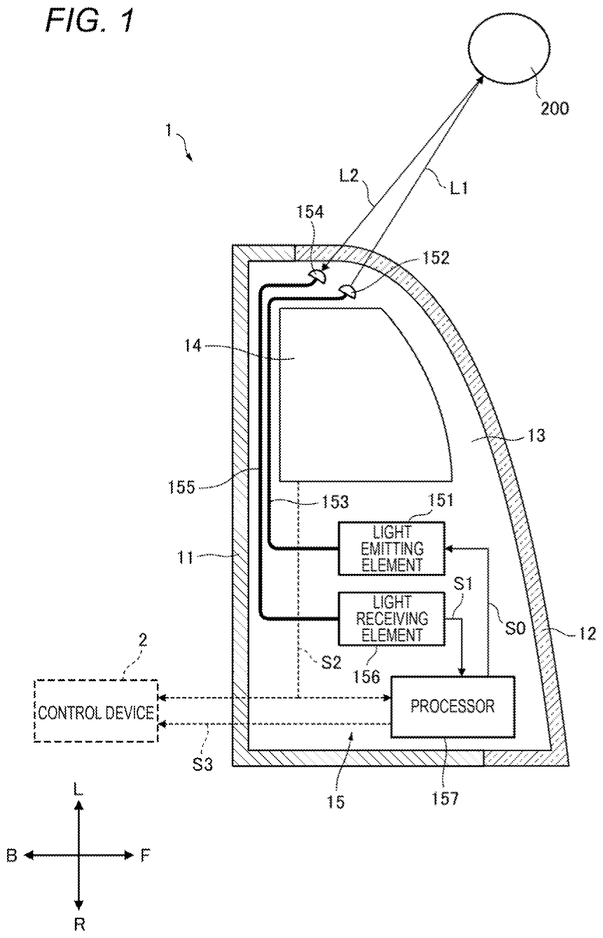

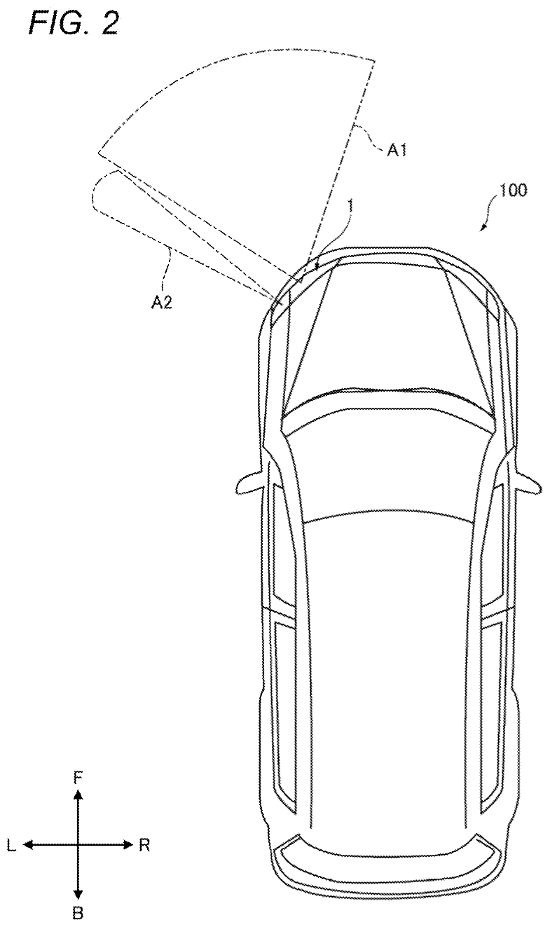

FIG. 1 illustrates a configuration of a sensor module 1 according to an embodiment. The sensor module 1 is equipped in a vehicle 100 illustrated in FIG. 2. In this example, the sensor module 1 is disposed at a left front portion of the vehicle 100. The left front portion is an area located on the left of the center in the left-right direction of the vehicle 100 and ahead of the center in the front-rear direction of the vehicle 100. The vehicle 100 is an example of a mobile entity.

As illustrated in FIG. 1, the sensor module 1 includes a housing 1I and a translucent cover 12. The housing 11 defines an accommodation space 13 together with the translucent cover 12. The translucent cover 12 forms a portion of an outer surface of the vehicle 100.

The sensor module 1 includes a LiDAR sensor 14. The LiDAR sensor 14 is disposed in the accommodation space 13.

The LiDAR sensor 14 has a configuration for emitting non-visible light and a configuration for detecting returned light as a result of the non-visible light being reflected by at least an object existing outside the vehicle 100. As required, the LiDAR sensor 14 may include a scan device that sweeps the non-visible light to change the light emitting direction (i.e., the detecting direction). For example, infrared light having a wavelength of 905 nm is used as the non-visible light.

The LiDAR sensor 14 can acquire the distance to the object associated with the returned light, for example, based on a time length from the time when the non-visible light is emitted in a certain direction to the time when the returned light is detected. Further, by accumulating such distance data in association with the detecting position, it is possible to acquire information as to the shape of the object associated with the returned light. Additionally or alternatively, information as to an attribute such as the material of the object associated with the returned light can be acquired based on the difference in waveforms between the emitted light and the returned light.

The sensor module 1 includes a ranging device 15. The ranging device 15 is disposed in the accommodation space 13. The ranging device 15 is a device for detecting a distance to an object 200 located outside the vehicle 100. The ranging device 15 includes a light emitting element 151, a first lens 152, a first optical fiber 153, a second lens 154, a second optical fiber 155, a light receiving element 156, and a processor 157.

The light emitting element 151 is configured and disposed so as to emit detecting light L1. As the detecting light L1, for example, infrared light having a wavelength of 905 nm can be used. As the light emitting element 151, a semiconductor light emitting element such as a laser diode or a light emitting diode can be used.

The first lens 152 is configured to allow the passage of the detecting light L1. The first optical fiber 153 is configured and disposed so as to guide the detecting light L1 emitted from the light emitting element 151 to the first lens 152. Specifically, the detecting light L1 emitted from the light emitting element 151 is incident on one end portion of the first optical fiber 153. As required, an optical system for converging the detecting light L1 to one end portion of the first optical fiber 153 can be provided. The incident detecting light L1 travels through the first optical fiber 153 and is emitted from the other end portion of the first optical fiber 153.

The detecting light L1 emitted from the first optical fiber 153 passes through the first lens 152 and the translucent cover 12 and is irradiated to the outside of the vehicle 100. When the object 200 is located in the traveling direction of the detecting light L1, the detecting light L1 is reflected by the object 200 to be reflected light L2 traveling toward the vehicle 100.

The second lens 154 is configured and disposed so as to allow the passage of the reflected light L2. The second optical fiber 155 is configured and disposed so as to guide the reflected light L2 that has passed through the second lens 154 to the light receiving element 156. Specifically, the reflected light L2 that has passed through the second lens 154 is incident on one end portion of the second optical fiber 155. The incident reflected light L2 travels through the second optical fiber 155 and is emitted from the other end portion of the second optical fiber 155. As required, an optical system for converging the light emitted from the other end portion of the second optical fiber 155 to the light receiving element 156 can be provided.

The light receiving element 156 is configured to output a detection signal S1 corresponding to the amount of incident light. As the light receiving element 156, a photodiode, a phototransistor, a photo resistor, or the like can be used. The ranging device 15 may include an amplifier circuit (not illustrated) for amplifying the detection signal S1.

The processor 157 is communicably connected to the light emitting element 151 and the light receiving element 156. The processor 157 outputs a control signal S0 for causing the light emitting element 151 to emit the detecting light L1 at a desired timing. The processor 157 receives the detection signal S1 outputted from the light receiving element 156.

The processor 157 includes an internal timer for measuring time. The processor 157 calculates the distance to the object 200 that generated the reflected light L2 based on a time length from the time when the detecting light L1 is emitted from the light emitting element 151 to the time when the reflected light L2 is incident on the light receiving element 156. Incidentally, an optical path length of the detecting light L1 traveling through the first optical fiber 153 and an optical path length of the reflected light L2 traveling through the second optical fiber 155 are considered.

The translucent cover 12 need not necessarily be transparent to visible light as long as it is transparent to the wavelength of the detecting light used in the LiDAR sensor 14 and the wavelength of the detecting light L1 used in the ranging device 15.

According to the ranging device 15 configured as described above, it is possible to alleviate the constraint on the positional relationship between the light emitting element 151 and the first lens 152. As long as the first lens 152 is disposed at a position allowing the passage of the detecting light L1 for detecting the distance to the object 200 located in a prescribed area outside the vehicle 100, the position of the light emitting element 151 can be determined with high flexibility in accordance with the circumstances of the first lens 152. This is because the detecting light L1 emitted from the light emitting element 151 so disposed can be guided to the first lens 152 by the first optical fiber 153 having flexibility and a length that can be freely determined.

Similarly, it is possible to alleviate the constraint on the positional relationship between the light receiving element 156 and the second lens 154. As long as the second lens 154 is disposed at a position allowing the passage of the reflected light L2 from the object 200 located in a prescribed area outside the vehicle 100, the position of the light receiving element 156 can be determined with high flexibility in accordance with the circumstances of the second lens 154. This is because the reflected light L2 that has passed through the second lens 154 can be guided to the light receiving element 156 so disposed by the second optical fiber 155 having flexibility and a length that can be freely determined.

Therefore, it is possible to improve the flexibility as to the layout of the ranging device 15 in the vehicle 100.

As illustrated in FIG. 2, the LiDAR sensor 14 is disposed so as to be able to detect information of an object located in a first area A1 outside the vehicle 100. On the other hand, the ranging device 15 is disposed so as to be able to detect a distance to an object located in a second area A2 different from the first area A1 outside the vehicle 100.

According to such a configuration, the detecting range of the ranging device 15 can be set so as to compensate for the blind spot of the detecting range of the LiDAR sensor 14. Even if the first lens 152 and the second lens 154 are arranged so as to realize such a detecting range, the layouts of the light emitting element 151 and the light receiving element 156 can be determined with high flexibility in accordance with the arrangement of the LiDAR sensor 14 in the accommodation space 13 by using the first optical fiber 153 and the second optical fiber 155 having flexibility and lengths that can be freely determined.

As illustrated in FIG. 1, the LiDAR sensor 14 may output a detection signal S2 corresponding to the detected information. The processor 157 of the ranging device 15 may integrate the information corresponding to the calculated distance to the object 200 with the information detected by the LiDAR sensor 14 based on the detection signal S1 received from the light receiving element 156 and the detection signal S2 received from the LiDAR sensor 14.

According to such a configuration, it is possible to efficiently supplement the information of an area that cannot be detected by the LiDAR sensor 14 with the information acquired by the ranging device 15 that is disposed so as to utilize the space with high efficiency.

Particularly, in this example, since the LiDAR sensor 14 capable of obtaining distance information to an object is used as the sensor for detecting the external information of the vehicle 100, integration with the distance information to the object obtained by the ranging device 15 can be facilitated. In this case, the detecting range of the LiDAR sensor 14 can be substantially extended.

Accordingly, in order to obtain the same advantage, at least one of the TOF camera and the millimeter wave radar can be used to obtain the distance information in addition to or instead of the LiDAR sensor 14.

The integration of the information acquired by the LiDAR sensor 14 and the information acquired by the ranging device 15 is not necessarily performed by the processor 157. As illustrated in FIG. 1, the processor 157 may output a detection signal S3 corresponding to the distance to the object 200. The detection signal S2 outputted from the LiDAR sensor 14 and the detection signal S3 outputted from the processor 157 can be inputted to a control device 2 that is independent of the processor 157. The control device 2 can be implemented by an ECU or the like equipped in the vehicle 100. The control device 2 may be provided as a part of the sensor module 1 or may be provided as a device independent of the sensor module 1. In this case, the integration of the information acquired by the LiDAR sensor 14 and the information acquired by the ranging device 15 is performed by the control device 2. The control device 2 in this case is also an example of the processor.

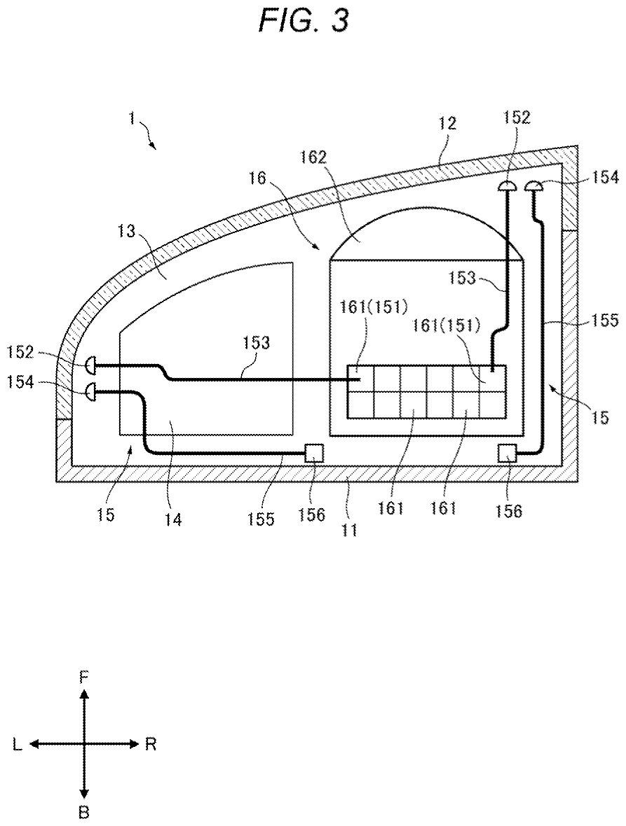

FIG. 3 illustrates a configuration of a sensor module 1 according to another embodiment. Components that are substantially the same as those of the sensor module 1 illustrated in FIG. 1 are assigned with the same reference numerals, and repetitive descriptions for those will be omitted. In FIG. 3, illustration of the processor 157 is omitted.

In the present embodiment, the sensor module 1 may include a lamp unit 16. The lamp unit 16 is a device for supplying illumination light to the outside of the vehicle 1X). Examples of the lamp unit 16 include a headlamp unit, a clearance lamp unit, a fog lamp unit, a direction indicator lamp unit, a tail lamp unit, a brake lamp unit, and a reversing lamp unit. The lamp unit 16 is disposed in the accommodation space 13.

The lamp unit 16 includes a plurality of light emitting elements 161. As the light emitting elements 161, semiconductor light emitting elements that emit light having a prescribed wavelength in the visible light range can be used. Examples of the semiconductor light emitting element include a light emitting diode, a laser diode, and an EL element. The lamp unit 16 includes an optical system 162. The light emitted from each light emitting element 161 travels in a prescribed direction outside the vehicle 100 by passing through the optical system 162.

In the present embodiment, a part of the light emitting elements 161 is used as the light emitting element 151 of the ranging device 15.

In this case, since the ranging device 15 can be configured using a part of an existing device having a lighting function, it is unnecessary to independently provide a power source and a circuit for driving the light emitting element for the ranging device 15. Since the limited accommodation space 13 can be used more efficiently, the flexibility as to the layout of the ranging device 15 is further enhanced.

In addition, by providing a plurality of ranging devices 15 as in the present embodiment, it is possible to further improve the capability of compensating for the blind spot in the detecting range of the LiDAR sensor 14.

The functions of the processor 157 described above can be implemented by a general-purpose microprocessor operating in cooperation with a general-purpose memory. Examples of the general-purpose microprocessor include a CPU and an MPU. Examples of the general-purpose memory include a ROM and a RAM. The functions of the processor 157 may be implemented by a part of an exclusive integrated circuit. Examples of the exclusive integrated circuit include a microcontroller, an FPGA, and an ASIC.

The above embodiments are merely examples for facilitating understanding of the gist of the presently disclosed subject matter. The configuration according to each of the above embodiments can be appropriately modified or improved without departing from the gist of the presently disclosed subject matter.

In each of the above embodiments, the LiDAR sensor 14 and the ranging device 15 are disposed in the same accommodation space 13, thereby forming the sensor module 1. However, the LiDAR sensor 14 and the ranging device 15 having different detecting ranges need not necessarily be disposed in the same accommodation space 13. In this case, the ranging device 15 may be regarded as one compensating for the detecting range of the LiDAR sensor 14 in the sensor system. As long as such compensation can be realized, the location of the ranging device 15 in the vehicle 100 can be appropriately determined.

The mobile entity equipped with the ranging device 15 is not limited to the vehicle 100. Examples of other mobile entities include railways, flying objects, aircrafts, and ships. The mobile entity equipped with the ranging device 15 may not require a driver.

The present application is based on Japanese Patent Application No. 2019-182171 filed on Oct. 2, 2019, the entire contents of which are incorporated herein by reference.

1. A ranging device adapted to be equipped in a mobile entity, comprising:
a light emitting element configured to emit detecting light;
a first lens configured to allow passage of the detecting light;
a first optical fiber configured to guide the detecting light to the first lens;
a second lens configured to allow passage of reflected light that is the detecting light reflected by an object;
a light receiving element;
a second optical fiber configured to guide the reflected light having passed the second lens to the light receiving element; and
a processor configured to calculate a distance to the object based on a time length from time when the detecting light is emitted from the light emitting element to time when the reflected light is incident on the light receiving element.

2. The ranging device according to claim 1,
wherein the light emitting element is a part of a plurality of light emitting elements configured to emit illumination light to outside of the mobile entity.

3. A sensor module adapted to be equipped in a mobile entity, comprising:
a housing defining an accommodation space;
a sensor disposed in the accommodation space and configured to detect information of a first area where is outside of the mobile entity;
a ranging device disposed in the accommodation space and configured to detect a distance to an object located in a second area where is outside of the mobile entity and different from the first area; and
a processor,
wherein the ranging device comprises:
a light emitting element configured to emit detecting light;
a first lens configured to allow passage of the detecting light;
a first optical fiber configured to guide the detecting light to the first lens;
a second lens configured to allow passage of reflected light that is the detecting light reflected by an object;
a light receiving element; and
a second optical fiber configured to guide the reflected light having passed the second lens to the light receiving element; and
wherein the processor is configured to calculate a distance to the object based on a time length from time when the detecting light is emitted from the light emitting element to time when the reflected light is incident on the light receiving element.

4. The sensor module according to claim 3, further comprising:
a plurality of light emitting elements disposed in the accommodation space and configured to emit illumination light to outside of the mobile entity,
wherein the light emitting element is a part of the light emitting elements.

5. The sensor module according to claim 3,
the processor is configured to integrate information corresponding to the distance with the information detected by the sensor.

6. The sensor module according to claim 5,
the sensor includes at least one of a LiDAR sensor, a TOF camera, and a millimeter radar.
